(19) United States
(12) Patent Application Publication
(10) Pub. No.: US 2010/0224495 A1
(43) Pub. Date: Sep. 9, 2010

(54) Real-time processing of water for hydraulic fracture treatments using a transportable frac tank

(76) Inventors: Dennis McGuire, Stuart, FL (US); Sanjeev Jakhete, Stuart, FL (US)

Correspondence Address: MCHALE & SLAVIN, P.A., 2855 PGA BLVD, PALM BEACH GARDENS, FL, 33410, US

(21) Appl. No.: 12/720,456

(22) Filed: Mar. 9, 2010

Related U.S. Application Data
(63) Continuation-in-part of application No. 12/399,481, filed on Mar. 6, 2009, now Pat. No. 7,699,988.
Application No. 12/399,481 is a continuation-in-part of application No. 12/184,716, filed on Aug. 1, 2008, now Pat. No. 7,699,994.
(60) Provisional application No. 60/953,584, filed on Aug. 2, 2007.

(51) Int. Cl. C02F 1/40

(52) U.S. Cl. 204/667

(57) ABSTRACT

A self contained, transportable, water pretreatment system and tank for use in a hydraulic treatment of subterranean formations with a well bore. The system treats recycled production water by electro-chemically generating mixed oxidants to sterilize the recycled water and to electro-chemically precipitate hardness without the addition of chemicals. The treatment system and tank form a self contained unit that is mounted with a truck trailer to facilitate easy and efficient relocation of the equipment.

### CROSS-REFERENCE TO RELATED APPLICATIONS

This application is a continuation-in-part of non provisional application Ser. No. 12/399,481 entitled Enhanced Water Treatment for Reclamation of Waste Fluids and Increased Efficiency Treatment of Potable Waters, filed Mar. 6, 2009 which is a continuation-in-part of non provisional patent application Ser. No. 12/184,716, entitled Enhanced Water Treatment for Reclamation of Waste Fluids and Increased Efficiency Treatment of Potable Waters, filed Aug. 1, 2008 which in turn is a continuation-in-part of provisional application 60/953,584, entitled Enhanced Water Treatment for Reclamation of Waste Fluids and Increased Efficiency Treatment of Potable Water, filed Aug. 2, 2007, the contents of which is hereby expressly incorporated by reference.

### FIELD OF THE INVENTION

This invention is related to the pre-treatment of fresh or produced water for a hydraulic fracture treatment of a subterranean formation in a well bore. The water is sterilized and softened with electro-chemical equipment installed on individual fracture treatment water storage tanks.

### BACKGROUND OF THE INVENTION

Due to droughts, over development, and/or widespread irrigation, a lowering of the potable water table around the country has occurred especially around Mid-Western cities. Because of the lower water table, significant oil and gas development has been curtailed due to the necessity of water required for current drilling techniques and completion of operations in the oil field. In addition, the present condition of the water supplies has increased the development planning time for shale oil and shale gas growth and may now include the need to build large ponds to retain surface water for oil and gas operations in rural areas. In arid regions, precipitation is not available to fill such ponds and if the area is populated, there may not be sufficient land available for the water storage. Therefore, the oil industry has had to develop methods to recycle produced water for drilling and production operations.

Recycling produced water has presented the oil industry with a new set of problems compared to using potable water from a city. Potable water is already sterilized, filtered, and has low salinity so the oil field service company adds biocide, an anti-scaling agent and sometimes friction reducer to the fracture treatment water storage tanks. If recycled water is stored in a pond or tank for long periods of time and it is usually contaminated with biological growth, crude oil, salts with scaling tendencies and drilling mud. Therefore, the service company has to filter the recycled water for clay sized particles, bio-slime and entrained oil droplets. Then, the filter recycled water has to be sterilized with a large amount biocide to prevent biological growth in the formation and it has to be treated with large amounts of anti-scalant to prevent precipitation with in-situ formation water.

When biocide and anti-scalants are diluted during production operations, they become food stuffs for anaerobic bacteria population that is living in the producing formation, production tubular, or in the bottom bio-film layer of the storage pond. Therefore, there exists the need for treating recycled water by electro-chemically generating mixed oxidants to sterilize the recycled water and to electro-chemically precipitate hardness without the addition of chemicals.

### DESCRIPTION OF THE PRIOR ART

U.S. Pat. No. 3,523,891 used a two staged electro-flotation, electro-oxidation cell with ozone injection into the first stage to remove suspended solids and to oxidize dissolved organic molecules from sewage effluent. Iron or aluminum sacrificial anodes were used to generate multivalent metallic hydroxides to create a flocculent that traps suspended solids and floats to the surface to form a frothy sludge. The ozone bubbles oxidize dissolved organic molecules, precipitate other dissolved solids and, with the negative surface charge, the bubbles attach to the individual flocculent pieces and float them to the surface for removal. The second stage cell used porous electrodes to create a large amount of 100 micron sized oxygen and hydrogen bubbles. The small gas bubbles were used for dissolved gas floatation polishing the treated effluent from the first stage cell. Ferric or aluminum sulfate could be added to the second cell to form ferric/aluminum hydroxide, an excellent micro-flocculent to improve water clarity. The patent also pointed out that polarity on the consumable electrodes had to switch to remove precipitated scale off the cathode face. The process monitored the dissolved iron and oxygen content in the treated water to correct for load variation.

U.S. Pat. No. 3,664,951 extended the electrochemical process to remove colloidal organic matter. By exposing the colloidal particles to different polarity plates in a bi-polar cell, the colloidal particles coalesce into larger particles that finally trap hydrogen bubbles generated on the cathode plate. The large particles float to the surface and form a froth that is mechanically removed.

U.S. Pat. No. 3,989,608 extended the electrochemical cell process to remove heavy metal ion contaminants from aqueous solutions using an iron alloy anode. The fine hydrogen bubbles from the cathode adhere to the tiny precipitate particles and cause the particle to float to the surface to make froth. An anionic or cationic surfactant can be used as a floatation promoter.

U.S. Pat. No. 7,481,937 used ozone oxidation and ultraviolet light disinfection to treat wastewater. The mechanically sheared ozone bubble mixture was also used to remove particles from the aqueous solution with the dissolve gas floatation technique.

U.S. Pat. No. 3,706,646 shows a method of removing scale build up on the cathode surface of an electrolytic cell. The primary purpose for the electrolytic cell is treatment of organic and inorganic waste materials. Scale build up was mostly calcium and magnesium salts of orthophosphate, carbonate and hydroxide. Discrete pressurized air slugs were used to create turbulence in the slot to remove the scale build up on the cathode surface. The anode coating was dimensionally stable for long term operation.

U.S. Pat. No. 5,897,765 discloses the method of scale precipitation on the cathode surface to soften and remove carbon dioxide from aqueous solutions. If more calcium ions are precipitated or if more carbonate ions are gasified, the pH of the solution can become more acidic or basic respectfully.

### SUMMARY OF THE INVENTION

The present invention is for the pre-treatment of water or brine used for fracturing oil and gas formations. During oil and gas well fracing operations, large amounts of fresh water are used. Typically the water is collected from a local natural source and then stored in 500 barrels (with a capacity 21000 gallons), also known as frac tanks. It is estimated that approx. 100,000 barrels of water are used during this operation. As water is used in the process, it is mixed with various chemicals including large amount of biocides to keep water bacteria free.

The instant invention is a transportable frac tank has a 500 bbls capacity and includes a self powered unit to condition water. The unit can be moved to the frac site where raw water will be pumped into transportable frac tank. The process uses ozone and electro-chemical oxidation to remove organics and disinfect the brine. It also uses electro-chemical precipitation of hardness ions to soften the water and ozone bubbles to flocculate colloidal sized particles. The overall pre-treatment eliminates the use of biocide and anti-scalant in the stored water for fracture treatment of a hydrocarbon bearing formation.

To allow self contained operation, the unit includes a diesel generator, an ozone generator and a DC power reactor. The diesel generator is capable of running continuous, on-board tanks are sized to allow operation for 24 hrs without refueling. When the raw water level has reached a set level within the frac tank an ozone booster pump will start. The raw water will then be introduced into an injector which will create a vacuum to induce ozone to mix with the raw water passing through the injector. The ozonated water is then circulated back into the tank and mixed uniformly with remaining ozone saturated water. The unit includes a plurality of insulated anodes and a cathode plate. The insulated anodes are connected to the positive DC supply and the plate is connected to the negative DC supply that in turn creates a flow of electrons from the anodes and precipitates the hardness salts. The ozone in the raw water will oxidize heavy metals, disinfect all microorganisms and will help coagulate suspended solids. The introduction of DC current in the raw water will precipitate the hardness salts.

Accordingly, it is an objective of the instant invention to eliminate the usage of biocide chemicals for the pretreatment of frac water.

It is a further objective of the instant invention to provide equipment for the pretreatment of frac water that is readily transportable from one well site to the next.

It is yet another objective of the instant invention to provide a transportable unit that includes frac water pretreatment processing equipment as well as a tank for holding the frac water.

It is a still further objective of the invention to provide a frac water pretreatment device that will reduce the amount of hardness causing salts in the raw frac water which will thereby eliminate the scaling problem within the equipment.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective side view of the frac water pretreatment truck trailer with side panels removed for clarity.

FIG. 2 is a perspective rear view of the frac water pretreatment truck trailer with the side panels removed for clarity.

FIG. 3 is another perspective side view of the frac water pretreatment truck trailer with the side panels removed for clarity.

FIG. 4 is a schematic diagram of the frac water pretreatment equipment.

### DETAILED DESCRIPTION OF THE INVENTION

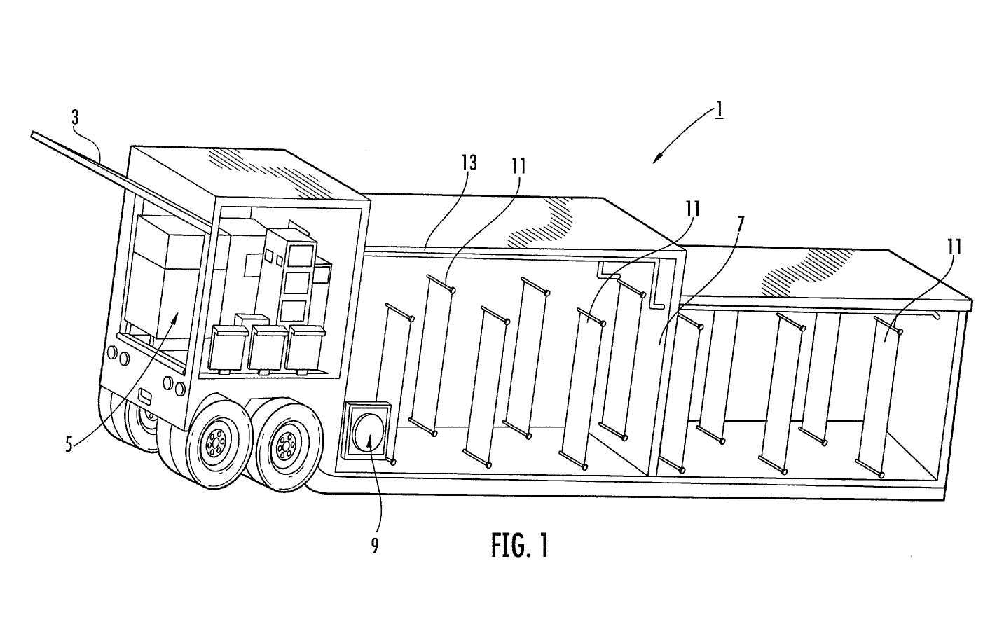

FIG. 1 shows the truck trailer 1 with the sides removed for the purposes of explanation. The truck trailer 1 is attachable to any type of road tractor to facilitate relocation. Likewise the truck trailer 1 can be moved by rail and or ship. The rear portion of the trailer 1 has a hinged access panel 3 to allow entrance into the control room 5 and the equipment assembled therein. The truck trailer 1 also has a tank 7 for holding and processing the raw water for use as frac water. Tank 7 has an inlet (not shown) to fill the tank with raw water as well as an outlet (not shown) to remove the treated water to be used as frac water. The tank 7 is a water tight vessel on truck trailer 1 and includes a manhole cover 9 to permit entrance for inspection, cleaning and repair of the equipment of equipment within tank 7. Tank 7 also includes a plurality, 12 by way of example, of perforated metal plates 11 vertically oriented and in spaced relationship within the tank 7. Perforated plates 11 are electrically connected to one another and to the negative side of a DC power supply. Perforated plates 11 serve as cathode plates when electrically charged. Also shown in FIG. 1 is a distribution pipe 13 that extends the length of the tank 7. Pipe 13 includes orifices designed to spray treated water on to the cathode plates 11.

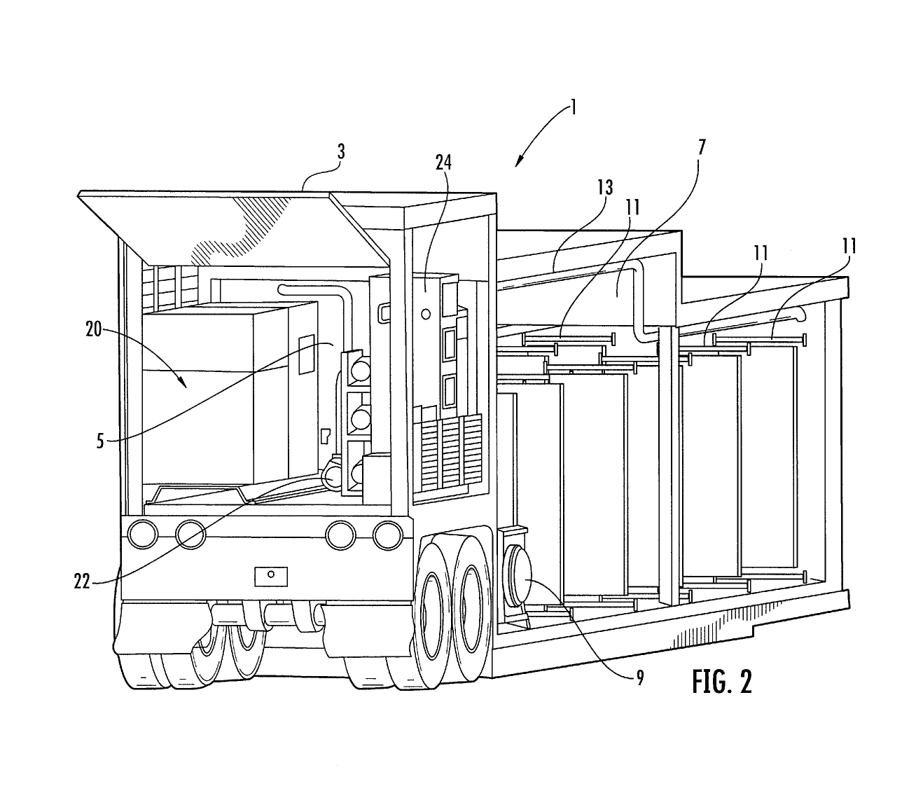

As shown in FIG. 2, control room 5 contains a diesel powered electrical generator 20, an ozone booster pump 22, an ozone generator 24 as well as various control devices and processing equipment.

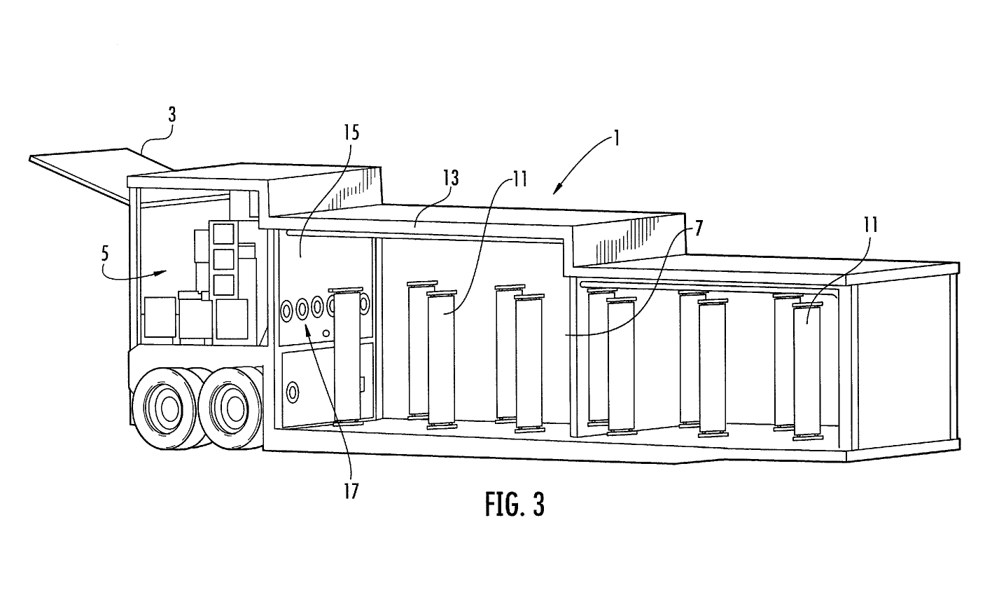

As can best be seen in FIG. 3, tank 7 has a wall 15 adjacent the control room 5. Mounted on wall 15 is a plurality of insulated anodes 17. Anodes 17 are electrically connected to one another and to the positive side of a DC power supply.

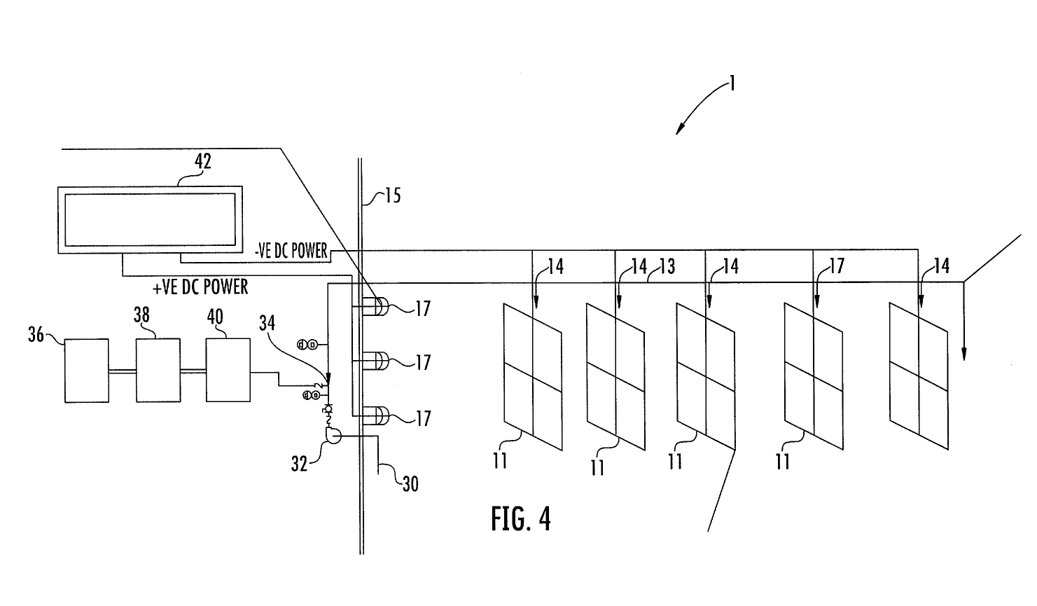

FIG. 4 is a schematic representation of the treatment system and tank assembled within truck trailer 1. Located in wall 15 near the bottom of tank 7 is an outlet pipe. The water within tank 7 is removed using and ozone booster pump 32. The outlet of ozone booster pump 32 directs the water a first inlet on ozone injector 34. Located between the first inlet of ozone injector 34 and the outlet is an area of reduced cross section creating a venturi passageway. A second inlet is located in the wall of the venturi passageway within the ozone injector 34. Under the influence of the negative pressure created at the second inlet of the ozone injector ozone is mixed with the water. Ozone is generated using an air compressor 36, which feeds an air separation unit 38, which in turn feeds ozone generator 40. The output of ozone generator is directed to second inlet on ozone injector 34. The ozonated water leaving the outlet of ozone injector 34 is fluidly connected to distribution pipe 13. The distribution pipe 13 runs the length of tank 7 and includes spray orifices designed to spray ozonated water over cathode plates 11 to reduce scaling thereon. The negative source from DC power supply 42 is connected to each of the cathode plates 11 and the positive source of power supply 42 is connected to each of the anodes 17. By way of example, DC power supply 42 is a 15 KW source at 110 volts DC and 150 amps.

In use, as tank 7 is being filled, when the water level exceeds approximately two feet a switch will activate pump 32 to circulate the water and the DC power supply 42 will supply current to the anodes 17 mounted in tank 7. Additionally, ozone gas made from concentrated oxygen at ozone generator 40 is inducted into the circulating water at the venturi section of the ozone injector 34. The ozonated circulated water will then exit into the tank through a distribution pipe 13 that can also act on the cathode return for the electrical circuit. Likewise, the cathode return can be independently wired.

The turbulence of the ozone bubbles will help maintain a clean cathode surface during tank fill up. Scale precipitated on the cathode pipe will flake off and settle to the bottom of the tank. The ozone bubbles will float the colloidal precipitant and oil droplets to the top of the tank where it will build up as a froth on the top of the water. Ozone injection into the perforated metal cathode plates 11 also removes the danger of explosive hydrogen gas build up in the vapor space in the top of the tank. The hydrogen ion is converted to HO² radical on the cathode surface instead of combining to form hydrogen gas.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for the pre-treatment of water or brine used for fracturing oil and gas formations comprising:
a truck trailer containing a water treatment system;
said truck trailer configured to be attached to a truck tractor such that the trailer can be moved from one location to another;
said truck trailer including a control room located in a partitioned space located on the truck trailer;
said truck trailer also including a liquid holding and treatment tank;
said water treatment system including a quantity of water in said liquid holding and treatment tank, a pump for fluidly conveying water from said liquid holding and treatment tank to a mixing device that mixes said water with a source of ozone, and a distribution pipe for returning the water to said liquid holding and treatment tank from said mixing device, said system further including a source of DC electrical energy that is electrically connected to at least one anode immersed in said water within said liquid holding and treatment tank.

2. The system for the pre-treatment of water or brine used for fracturing oil and gas formations as set forth in claim 1 wherein said source of ozone includes an air compressor which feeds an air separation unit which in turn feeds ozone generator.

3. The system for the pre-treatment of water or brine used for fracturing oil and gas formations as set forth in claim 1 wherein said mixing device is an injector having an ozone inlet located within a venturi passageway within said injector.

4. The system for the pre-treatment of water or brine used for fracturing oil and gas formations as set forth in claim 1 wherein the source of DC electrical energy has a positive source that is electrically connected to a plurality of anodes mounted in a wall of said liquid holding and treatment tank.

5. The system for the pre-treatment of water or brine used for fracturing oil and gas formations as set forth in claim 1 wherein the source of DC electrical energy has a negative source that is electrically connected to a plurality of cathodes mounted within said holding and treatment tank.

6. The system for the pre-treatment of water or brine used for fracturing oil and gas formations as set forth in claim 5 wherein each of said plurality of cathodes is a perforated plate that is vertically supported within said liquid holding and treatment tank.

7. The system for the pre-treatment of water or brine used for fracturing oil and gas formations as set forth in claim 6 wherein said distribution pipe includes a plurality of spray orifices designed to spray the water mixed with ozone over said cathode plates to reduce scaling thereon.

8. The system for the pre-treatment of water or brine used for fracturing oil and gas formations as set forth in claim 1 wherein the water mixed with ozone will float colloidal precipitant and oil droplets to the top of the tank where it will build up as froth on top of the water.

9. The system for the pre-treatment of water or brine used for fracturing oil and gas formations as set forth in claim 1 said source of DC electrical energy is mounted in the control room.

10. The system for the pre-treatment of water or brine used for fracturing oil and gas formations as set forth in claim 1 wherein said pump, said source of ozone and said mixing device are mounted in said control room.

11. The system for the pre-treatment of water or brine used for fracturing oil and gas formations as set forth in claim 1 wherein said truck trailer is sized and configured to be transportable by rail car, or shipping vessel.

12. The system for the pre-treatment of water or brine used for fracturing oil and gas formations as set forth in claim 1 wherein said liquid holding and treatment tank has a capacity greater than two hundred thousand gallons.
